(19) United States
(12) Patent Application Publication
(10) Pub. No.: US 2020/0400199 A1
(43) Pub. Date: Dec. 24, 2020

(54) FRICTION PLATE AND CLUTCH ASSEMBLY INCLUDING THE SAME

(71) Applicant: BorgWarner Inc., Auburn Hills, MI (US)

(72) Inventors: John Ramirez, Plainfield, IL (US); Timothy Krzyskowski, Orland Park, IL (US); David T. Vierk, Mokena, IL (US); Richard W. Pridgen, JR., Arlington Heights, IL (US); Paul H. Elsesser, Glen Ellyn, IL (US); Benjamin A. Siegel, Chicago, IL (US)

(21) Appl. No.: 16/444,333

(22) Filed: Jun. 18, 2019

(51) Int. Cl. F16D 13/64

(52) U.S. Cl. CPC F16D 13/64; F16D 13/648; F16D 2250/0023; F16D 2200/003

(57) ABSTRACT

A friction plate includes a core plate defining a bore. The core plate includes an interior core surface defining the bore, an exterior core surface radially spaced from the interior core surface, a first clutch face extending between the interior core surface and the exterior core surface and facing a first direction, and a second clutch face extending between the interior core surface and the exterior core surface and facing a second direction opposite the first direction. The friction plate also includes a friction material disposed on at least one of the first and second clutch faces. A first thickness is defined between the first and second clutch faces on a spline portion. A second thickness is defined between the first and second clutch faces on a friction portion. The first thickness is greater than the second thickness.

### BACKGROUND OF THE INVENTION

### 1. Field of the Invention

The present invention generally relates to a friction plate and, more specifically, to a friction plate for use in a clutch assembly of a friction system.

### 2. Description of the Related Art

Several components of a motor vehicle powertrain may employ a friction system to facilitate the transfer of power from the motor vehicle's power generator (e.g., an internal combustion engine, electric motor, fuel cell, etc.) to drive wheels of the motor vehicle. A transmission, located downstream from the power generator that enables vehicle launch, gear shifting, and other torque transfer events, is one such component that may employ a friction system. Some form of a clutch assembly may be found throughout many different types of transmissions currently available for motor vehicle operation. A clutch assembly may be utilized in a torque converter for an automatic transmission, in a multi-plate clutch pack for an automatic transmission or a semi-automatic dual-clutch transmission (DCT), and in a start clutch that may be incorporated into an automatic transmission equipped with as many as seven to ten gears as a substitute for the torque converter, to name but a few examples. Similar clutch assemblies may be found elsewhere in the vehicle powertrain besides the transmission.

The clutch assembly typically includes a plurality of friction plates rotatably coupled to a shaft, with the plurality friction plates being used to interlock two or more opposed, rotating surfaces by imposing selective interfacial frictional engagement between those surfaces. Each friction plate includes a core plate defining a bore for receiving the shaft such that each friction plate is rotatably coupled to the shaft. Each friction plate additionally includes a friction material disposed on the core plate, which effectuates the intended frictional engagement between the plurality of friction plates.

During operation, conventional friction plates move between an engaged position where the plurality friction plates are engaged with one another, and a disengaged position where the plurality friction plates are disengaged from one another. However, clutch assemblies include conventional friction plates which are heavy and bulky to provide the strength necessary to withstand stress experienced during operation. Other clutch assemblies have reduced axial space of the friction plate by reducing the amount of friction material disposed on the core plate. However, this leads to potentially dangerous hot spots and decreased life of the friction plate.

As such, there remains a need to provide an improved friction plate for a clutch assembly.

### SUMMARY OF THE INVENTION AND ADVANTAGES

A friction plate for is used in a clutch assembly that includes a shaft. The friction plate includes a core plate defining a bore extending along an axis and adapted to receive and be rotatably coupled to the shaft. The core plate includes an interior core surface defining the bore, an exterior core surface radially spaced from the interior core surface with respect to the axis such that the exterior core surface surrounds the interior core surface about the axis, a first clutch face extending between the interior core surface and the exterior core surface and facing a first direction along the axis, and a second clutch face extending between the interior core surface and the exterior core surface and facing a second direction opposite the first direction along the axis. The friction plate also includes a friction material disposed on at least one of the first and second clutch faces. Additionally, the core plate is an unbent body and includes a spline portion having a first thickness defined between the first and second clutch faces with respect to the axis, and a friction portion having a second thickness defined between the first and second clutch faces with respect to the axis. Finally, the first thickness is greater than the second thickness. A method of producing the core plate is also disclosed herein.

Accordingly, the core plate including a spline portion having a first thickness which is greater than a friction portion having a second thickness creates a reduction in axial thickness of the friction plate, which ultimately leads to weight reduction, potential for improved shift feel and hot spot resistance, increased friction plate life, and improved torque carrying capacity.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a clutch assembly including a plurality of friction plates in a transmission;

FIG. 2A is a cross-sectional view of the plurality of friction plates in an engaged state;

FIG. 2B is a cross-sectional view of the plurality of friction plates, including a core plate and a friction material, with the plurality of friction plates in a disengaged state;

FIG. 3 is a side cross-sectional view of the core plate and friction material of FIG. 2A having the separator plates and shaft removed;

FIG. 4 is a side view of the core plate;

FIG. 5 is a side cross-sectional view of the core plate of FIG. 3 taken along line 5-5; and

FIG. 6 is a partial front cross-sectional view of the core plate.

### DETAILED DESCRIPTION OF THE INVENTION

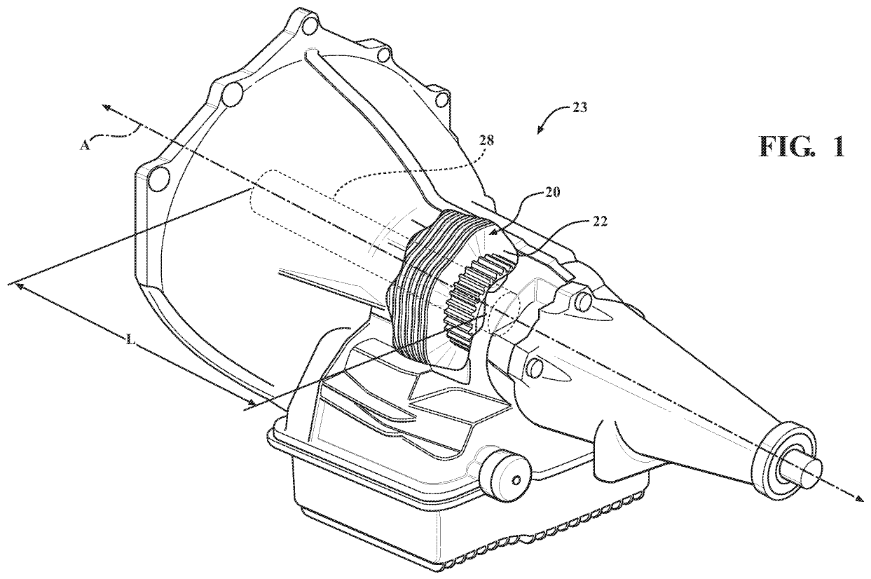

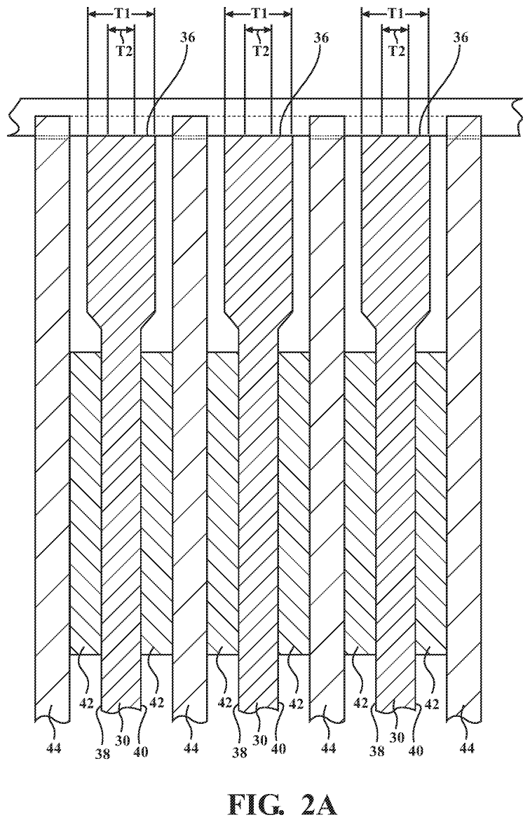

With reference to the Figures, wherein like numerals indicate like parts throughout the several views, a clutch assembly 20 including a friction plate 22 is generally shown in FIG. 1. The friction plate 22 is used in the clutch assembly 20 for use in a friction system 23. The friction system 23 may be a wet friction system, a semi-wet friction system, or a dry friction system. Examples of friction systems include transmissions, particularly automatic transmissions, continuously variable transmissions, automated manual transmissions, dual clutch transmissions, friction brake systems, and the like. With reference to FIGS. 2A and 2B, the clutch assembly 20 includes a housing defining a clutch interior. The friction plate 22 is disposed in the clutch interior. With reference to FIG. 1, the clutch assembly 20 also includes a shaft 28 having a length L and an axis A extending along the length L.

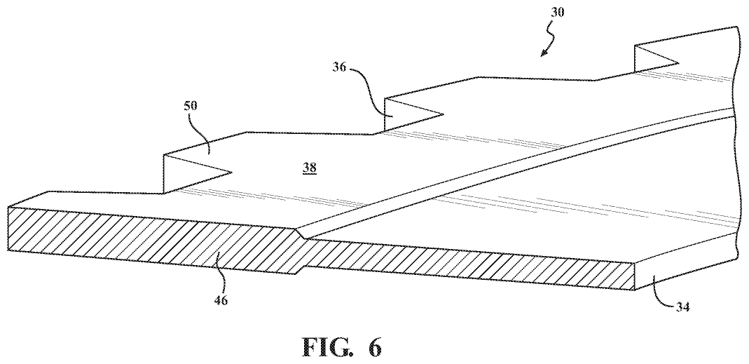

With reference to FIGS. 2A through 6B, the friction plate 22 includes a core plate 30 defining a bore 32 extending along the axis A. The bore 32 receives the shaft 28 such that the core plate 30 is rotatably coupled to the shaft 28. The shaft 28 is also commonly referred to as a hub. The core plate 30 includes an interior core surface 34 defining the bore 32, and an exterior core surface 36 radially spaced from the interior core surface 34 with respect to the axis A such that the exterior core surface 36 surrounds the interior core surface 34 about the axis A. The core plate 30 also includes a first clutch face 38 extending between the interior core surface 34 and the exterior core surface 36 and facing a first direction along the axis A. The core plate 30 further includes a second clutch face 40 extending between the interior core surface 34 and the exterior core surface 36 and facing a second direction opposite the first direction along the axis A.

With particular reference to FIGS. 2A and 2B, the friction plate 22 includes a friction material 42 disposed on at least one of the first and second clutch faces 38, 40. Typically, the friction plate 22 includes the friction material 42 on both the first and second clutch faces 38, 40. However, it is to be appreciated that the friction plate 22 may have the friction material 42 on only one of the first clutch face 38 or the second clutch face 40. For example, when the clutch assembly 20 includes a plurality of friction plates 22, each of the friction plates 22 are disposed about the axis A such that clutch assembly 20 includes two friction plates 22 sandwiching the other friction plates 22 between one another with respect to the axis A. In such cases, each of the two friction plates 22 sandwiching the other friction plates 22 typically only have the friction material 42 on one of the first and second clutch faces 38, 40. Typically, the clutch assembly 20 includes a plurality of separator plates 44 disposed between the friction plates 22. The plurality of separator plates 44 help move the friction plates 22 between an engaged position, as shown in FIG. 2A, and a disengaged position, as shown in FIG. 2B.

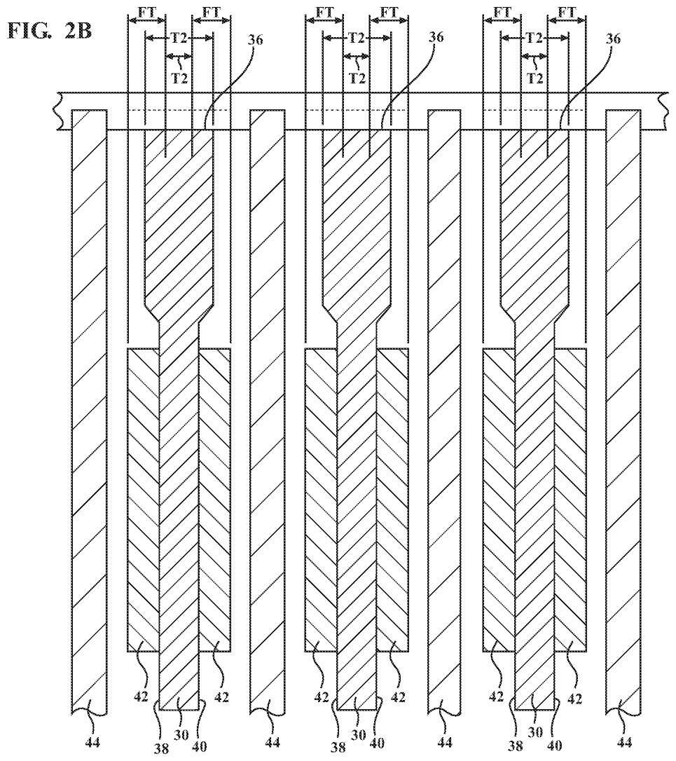

Referring now to FIGS. 3-6, the core plate 30 is an unbent body and comprises a spline portion 46 and a friction portion 48. As used herein, an unbent body is a body which is not bent along its length and/or width and/or thickness during or after formation of the core plate 30. However, if the core plate 30 is produced from a coiled material, the coiled material may begin coiled but form an unbent body during the formation process without additional bending. In the example illustrated in FIG. 3, the spline portion 46 includes the exterior core surface 36, as the exterior core surface 36 includes a plurality of teeth 50 configured to engage a toothed portion of another component. However, it is also contemplated that the spline portion 46 may alternatively include the interior core surface 34 of the core plate 30 such that the plurality of teeth 50 are arranged on the interior core surface 34. Moreover, the friction portion 48 of the core plate 30 is configured to withstand any load on the core plate 30 during operation and is disposed opposite the spline portion 46. For example, if the spline portion 46 includes the exterior core surface 36 of the core plate 30, the friction portion 48 includes the interior core surface 34, and vice versa.

Referring still to FIGS. 3-6, the core plate 30 has a first thickness T1 defined between the first and second clutch faces 38, 40 with respect to the axis A, and a friction portion 48 having a second thickness T2 defined between the first and second clutch faces 38, 40 with respect to the axis A. Moreover, the first thickness T1 is greater than the second thickness T2. In one example, the first thickness T1 is at least 25 percent greater than the second thickness T2. In another example, the first thickness T1 is between 25 percent and 75 percent greater than the second thickness T2. In yet another example, the first thickness T1 is more than 50 percent greater than the second thickness T2. In yet another example, the first thickness T1 is at least 60 percent greater than the second thickness T2.

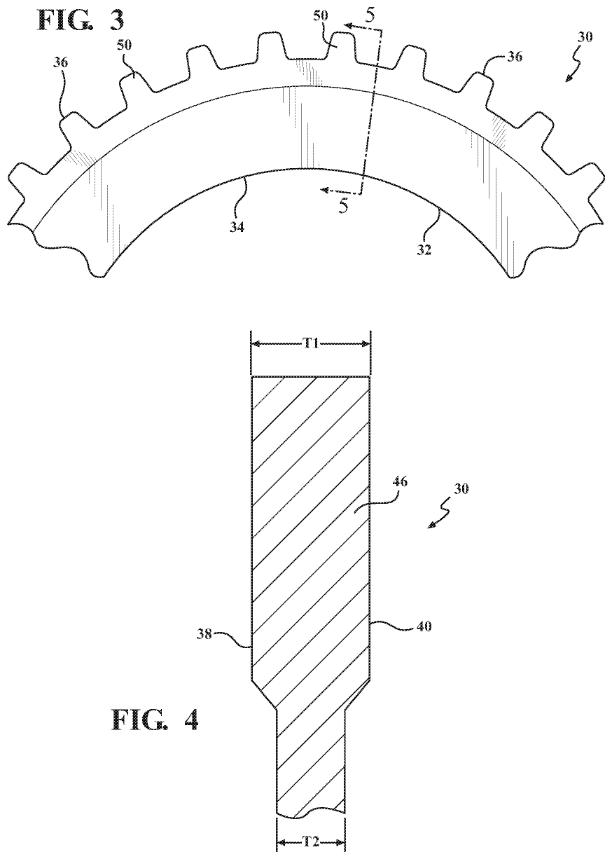

Referring still to FIGS. 3-6, the core plate 30 is a single solid body. More specifically, the core plate 30 is solid between the interior core surface 34 and the exterior core surface 36 about an entire circumference of the core plate 30 between the interior core surface 34 and the exterior core surface 36, i.e. the core plate is not hollow. Moreover, as best illustrated in FIG. 4, the core plate 30 is stepped between the spline portion 46 and the friction portion 48. As best shown in FIG. 4, the core plate 30 is stepped between the spline portion 46 and the friction portion 48 such that an angled portion 47 connects the spline portion 46 and the friction portion 48 at an angle. The angle may be any angle, including but not limited to an angle in the range of 15-85 degrees. It is also contemplated that the core plate 30 may have another cross section, such as a substantially frustoconical, frustopentagonal, frustopyramidal or the like, without departing from the spirit of the disclosure.

The core plate 30 may be comprised of any suitable material for use in the friction system 23. For example, the core plate 30 may be comprised of a metallic material. Such metallic materials that may be used include, but are not limited to, stainless steel, mild carbon steel, aluminum, and may contain surface treatments, such as phosphate coating, nickel coating, anodizing, and the like. As another example, the core plate 30 may be comprised of a polymeric material. Such polymeric materials that may be used include thermoset materials and thermoplastic materials. Such thermoset materials that may be used include polyester, vinyl ester, epoxy, phenolic, urethane, polyamide, polyimide, and the like. Such thermoplastic materials that may be used include polyethylene terephthalate (PET), polypropylene, polycarbonate, polybutylene terephthalate (PBT), vinyl, polyethylene, polyvinyl chloride (PVC), and the like. When the polymeric material is used, the polymeric material may be used as a straight polymeric material, or may be used with reinforcement in the polymeric material, such as metal, fiberglass, carbon fiber, and the like.

A method of making the core plate 30 of the friction plate 22 for use in the clutch assembly 20 includes the step of blanking a coil stock material to form an inner diameter. As described above, the coil stock material may be comprised of aluminum, stainless steel, or another suitable material. Next, the coil stock material is coined until a desired thickness is reached. Typically, reaching the desired thickness requires coining the coil stock material at least twice including coining the coil stock material two times, three times, four times, five times, or the like. Once the coil stock material is coined to the desired thickness, the coil stock material is blanked to remove distortion from the inner diameter. Finally, the coil stock material is blanked again to form an outer diameter.

In another example, the core 30 plate may be formed by casting or another method as desired.

Furthermore, when the core plate 30 comprises a polymeric material, the making of the core plate 30 may include injection molding the core plate 30 having the first thickness T1 being greater than the second thickness T2. Injection molding the core plate 30 when the core plate 30 comprises a polymeric material allows the core plate 30 to have the desired thicknesses, such as the configuration illustrated in FIGS. 3-6.

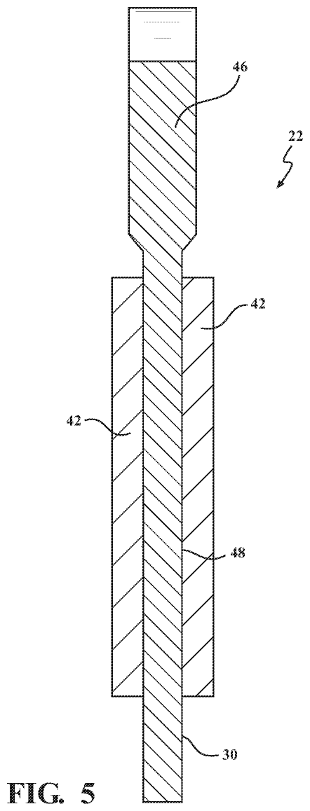

Referring now to FIG. 5, the cross-sectional shape of the core plate 30 such that the thickness T1 of the spline portion 46 is greater than the thickness T2 of the friction portion 48 allows the friction material 42 to also have a varied thickness. More specifically, the friction material 42 which is disposed adjacent to the friction portion 48 is thicker than the friction material 42 disposed adjacent to the spline portion 46, because the friction portion 48 has a smaller thickness than the spline portion 46. The additional friction material 42 disposed adjacent to the friction portion 48 improves shift feel to a driver, prevents potentially damaging hot spots, and increases the overall life of the core plate 30.

Moreover, having the thickness T1 of the spline portion 46 greater than the thickness T2 of the friction portion 48 reduces overall axial thickness, which allows for the addition of an extra core plate 30 to improve torque carrying capacity and/or allows for the use of thicker separator plates which can be used as an additional heat sink source, preventing hot spots. Additionally, the core plate 30 disclosed herein improves axial spacing while having a similar torque carrying capacity as a conventional core plate 30.

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

What is claimed is:

1. A friction plate for use in a clutch assembly including a shaft, said friction plate comprising:
a core plate defining a bore extending along an axis and adapted to receive and be rotatably coupled to the shaft, with said core plate comprising:
an interior core surface defining said bore;
an exterior core surface radially spaced from said interior core surface with respect to said axis such that said exterior core surface surrounds said interior core surface about said axis;
a first clutch face extending between said interior core surface and said exterior core surface and facing a first direction along said axis; and
a second clutch face extending between said interior core surface and said exterior core surface and facing a second direction opposite said first direction along said axis; and
a friction material disposed on at least one of said first and second clutch faces;
wherein said core plate is an unbent body and comprises a spline portion having a first thickness defined between said first and second clutch faces with respect to said axis, and a friction portion having a second thickness defined between said first and second clutch faces with respect to said axis, and wherein said first thickness is greater than said second thickness.

2. The friction plate of claim 1, wherein said core plate is solid between said interior core surface and said exterior core surface.

3. The friction plate of claim 1, wherein said core plate is single piece.

4. The friction plate of claim 1, wherein said core plate is stepped between said spline portion and said friction portion.

5. The friction plate of claim 1, wherein said spline portion comprises said exterior core surface.

6. The friction plate of claim 5, wherein said friction portion comprises said interior core surface.

7. The friction plate of claim 1, wherein said first thickness is at least 25 percent greater than said second thickness.

8. The friction plate of claim 1, wherein said first thickness is between 25 percent and 75 percent greater than said second thickness.

9. The friction plate of claim 1, wherein said first thickness is more than 50 percent greater than said second thickness.

10. The friction plate of claim 1, wherein said first thickness is at least 60 percent greater than said second thickness.

11. The friction plate of claim 1, wherein said core plate is comprised of aluminum.

12. A clutch assembly comprising:
a housing defining a clutch interior;
a shaft disposed in said clutch interior and having a length and an axis extending along said length; and
a friction plate disposed in said clutch interior, said friction plate comprising:
a core plate defining a bore extending along an axis and adapted to receive and be rotatably coupled to the shaft, with said core plate comprising:
an interior core surface defining said bore;
an exterior core surface radially spaced from said interior core surface with respect to said axis such that said exterior core surface surrounds said interior core surface about said axis;
a first clutch face extending between said interior core surface and said exterior core surface and facing a first direction along said axis; and
a second clutch face extending between said interior core surface and said exterior core surface and facing a second direction opposite said first direction along said axis; and
a friction material disposed on at least one of said first and second clutch faces;
wherein said core plate is a solid unbent body and comprises a spline portion having a first thickness defined between said first and second clutch faces with respect to said axis, and a friction portion having a second thickness defined between said first and second clutch faces with respect to said axis, and wherein said first thickness is greater than said second thickness.

13. The clutch assembly of claim 12, wherein said core plate is solid between said interior core surface and said exterior core surface.

14. The clutch assembly of claim 12, wherein said core plate is single piece.

15. The clutch assembly of claim 12, wherein said core plate is stepped between said spline portion and said friction portion.

16. The clutch assembly of claim 12, wherein said spline portion comprises said exterior core surface.

17. The clutch assembly of claim 12, wherein said first thickness is more than 50 percent greater than said second thickness.

18. A method of making a core plate of a friction plate for use in a clutch assembly, said method comprising:
blanking a coil stock material to form an inner diameter;
coining the coil stock material until a desired thickness is reached;
blanking the coil stock material to remove distortion from the inner diameter; and
blanking the coil stock material to form an outer diameter.

19. The method as set forth in claim 18, wherein the core plate comprises aluminum.

20. The method as set forth in claim 18, wherein the step of coining the coil stock material includes coining the coil stock material at least twice.
